(19) United States
(12) Patent Application Publication
(10) Pub. No.: US 2024/0258007 A1
(43) Pub. Date: Aug. 1, 2024

(54) MULTILAYER COIL COMPONENT

(71) Applicant: Murata Manufacturing Co., Ltd., Kyoto-fu (JP)

(72) Inventors: Shun TAKAI, Nagaokakyo-shi (JP); Kenjirou KOSHIJI, Nagaokakyo-shi (JP); Rika YAMADA, Nagaokakyo-shi (JP); Yasushi TAKEDA, Nagaokakyo-shi (JP)

(73) Assignee: Murata Manufacturing Co., Ltd., Kyoto-fu (JP)

(21) Appl. No.: 18/527,766

(22) Filed: Dec. 4, 2023

(30) Foreign Application Priority Data
Jan. 27, 2023 (JP) 2023-010689

(51) Int. Cl. H01F 17/00; H01F 27/32; H01F 27/34

(52) U.S. Cl. CPC H01F 17/0013; H01F 27/323; H01F 27/346; H01F 2017/002; H01F 27/292

(57) ABSTRACT

A multilayer coil component includes a multilayer body including plurality of stacked insulating layers, a coil, and first and second connection conductors thereinside; and first and second outer electrodes that are electrically connected to the coil. The coil is configured by electrically connecting a plurality of coil conductors, which are stacked together with the insulating layers, to one another. The multilayer body has first and second end surfaces, which face each other in a length direction, first and second main surfaces, which face each other in a height direction perpendicular to the length direction, and first and second side surfaces, which face each other in a width direction perpendicular to the length and height directions. The first outer electrode covers at least part of the first end surface and extends from the first end surface and cover part of the first main surface.

### CROSS-REFERENCE TO RELATED APPLICATION

This application claims benefit of priority to Japanese Patent Application No. 2023-010689, filed Jan. 27, 2023, the entire content of which is incorporated herein by reference.

### BACKGROUND

### Technical Field

The present disclosure relates to a multilayer coil component.

### Background Art

A multilayer electronic component is disclosed in Japanese Unexamined Patent Application Publication No. 2004-207608. The multilayer electronic component is manufactured by forming concave grooves in green sheets, applying a plurality of pieces of conductive paste horizontally and vertically in the concave grooves, stacking a plurality of the green sheets so as to form a plurality of coils inside the stacked green sheets, cutting the stacked green sheets into individual components, firing each component, and providing terminal electrodes at both ends of each component. Coil conductors formed using the conductive paste are characterized in that, in the cross sectional shape thereof after firing, parts of the coil conductors overlap both sides of the concave grooves, and the aspect ratio t/w of the thickness t to the width w of the cross section of the coil conductors is greater than or equal to 0.7.

When an axial direction of a coil is parallel to a mounting surface, as is the case in the multilayer electronic component described in Japanese Unexamined Patent Application Publication No. 2004-207608, stray capacitances generated between the coil and outer electrodes can be reduced.

In order to further reduce stray capacitances, the present inventors considered forming the outer electrodes only on parts of the end surfaces and side surfaces of the multilayer body in order to reduce the areas of the outer electrodes that face the coil. However, when the outer electrodes are formed only on parts of the end surfaces and side surfaces of the multilayer body, it is not possible to discriminate where the outer electrodes are to be formed by simply looking at the top and bottom surfaces, the side surfaces, and the end surfaces of the multilayer body. Therefore, automating the discrimination process using sensors and so forth would also be difficult.

Therefore, the present inventors decided to provide a mark (discrimination mark) for discriminating where the outer electrodes are to be formed. However, the inventors found that if the determination mark is too small, the mark itself might not be well exposed at the mounting surface if cutting misalignment of a multilayer body block occurs during manufacture.

Therefore, the inventors considered simply increasing the size of the discrimination mark, but this conversely led to an increase in stray capacitance.

### SUMMARY

According, the present disclosure provides a multilayer coil component that includes a discrimination mark that is large enough to be exposed even if cutting misalignment occurs and allows an increase in stray capacitance to be suppressed.

A multilayer coil component of the present disclosure includes: a multilayer body formed by stacking a plurality of insulating layers and including a coil, a first connection conductor, and a second connection conductor thereinside; and a first outer electrode and a second outer electrode that are electrically connected to the coil. The coil is formed by electrically connecting a plurality of coil conductors, which are stacked together with the insulating layers, to one another. The multilayer body has a first end surface and a second end surface, which face each other in a length direction, a first main surface and a second main surface, which face each other in a height direction perpendicular to the length direction, and a first side surface and a second side surface, which face each other in a width direction perpendicular to the length direction and the height direction. The first outer electrode is disposed so as to cover at least part of the first end surface and so as to extend from the first end surface and cover part of the first main surface. The second outer electrode is disposed so as to cover at least part of the second end surface and so as to extend from the second end surface and cover part of the first main surface. The first connection conductor is connected between a part of the first outer electrode that covers the first end surface and the coil conductor that faces that part of the first outer electrode. The second connection conductor is connected between a part of the second outer electrode that covers the second end surface and the coil conductor that faces that part of the second outer electrode. An axial direction of the coil is parallel to the first main surface. A first discrimination mark is provided on a surface of the multilayer body, excluding the first end surface and the second end surface, at a location where the first outer electrode is disposed. The first discrimination mark includes a first mark conductor pattern that is in contact with an inner surface of the first outer electrode and extends along a plane perpendicular to the axial direction of the coil. The first mark conductor pattern is provided with a cutout part at a location opposite a coil axis of the coil.

According to the present disclosure, a multilayer coil component can be provided that includes a discrimination mark that is large enough to be exposed even when cutting misalignment occurs, and allows an increase in stray capacitance to be suppressed.

### BRIEF DESCRIPTION OF THE DRAWINGS

FIG. 1 is a perspective view schematically illustrating a multilayer coil component according to a First Embodiment of the present disclosure;

FIG. 2A is a side view of the multilayer coil component illustrated in FIG. 1;

FIG. 2B is a front view of the multilayer coil component illustrated in FIG. 1;

FIG. 2C is a bottom view of the multilayer coil component illustrated in FIG. 1;

FIG. 3 is an exploded plan view schematically illustrating an example of a multilayer body of the multilayer coil component illustrated in FIG. 1;

FIG. 4A is a side view schematically illustrating in a see-through manner an example of the internal structure of the multilayer body of the multilayer coil component according to the First Embodiment of the present disclosure;

FIG. 4B is a front view schematically illustrating in a see-through manner an example of the internal structure of the multilayer body of the multilayer coil component according to the First Embodiment of the present disclosure;

FIG. 4C is a bottom view schematically illustrating an example of a first main surface of the multilayer body of the multilayer coil component according to the First Embodiment of the present disclosure;

FIG. 5 is a front view schematically illustrating in a see-through manner an example of the internal structure of a multilayer body block of a multilayer coil component according to a comparative example of the present disclosure in which the positional relationship between the multilayer body block and cutting lines is illustrated;

FIG. 6 is a front view corresponding to FIG. 4B and illustrates the positional relationship between the multilayer body block and cutting lines;

FIG. 7 is a front view schematically illustrating in a see-through manner another example of the internal structure of the multilayer body of the multilayer coil component according to the First Embodiment of the present disclosure in which a First Modification of a cutout part is illustrated;

FIG. 8 is a front view schematically illustrating in a see-through manner yet another example of the internal structure of the multilayer body of the multilayer coil component according to the First Embodiment of the present disclosure in which a Second Modification of a cutout part is illustrated;

FIG. 9 is a front view schematically illustrating an example of a step of cutting a multilayer body block of the multilayer coil component according to the First Embodiment of the present disclosure;

FIG. 10 is an exploded plan view schematically illustrating an example of a multilayer body of a multilayer coil component according to a Second Embodiment of the present disclosure;

FIG. 11A is a side view schematically illustrating in a see-through manner an example of the internal structure of a multilayer body of the multilayer coil component according to the Second Embodiment of the present disclosure;

FIG. 11B is a front view schematically illustrating in a see-through manner an example of the internal structure of the multilayer body of the multilayer coil component according to the Second Embodiment of the present disclosure;

FIG. 11C is a bottom view schematically illustrating an example of a first main surface of the multilayer body of the multilayer coil component according to the Second Embodiment of the present disclosure;

FIG. 12 is a front view schematically illustrating in a see-through manner another example of the internal structure of the multilayer body of the multilayer coil component according to the Second Embodiment of the present disclosure in which a First Modification of a cutout part is illustrated; and

FIG. 13 is a front view schematically illustrating in a see-through manner yet another example of the internal structure of the multilayer body of the multilayer coil component according to the Second Embodiment of the present disclosure in which a Second Modification of a cutout part is illustrated.

### DETAILED DESCRIPTION

Hereafter, a multilayer coil component of the present disclosure will be described. However, the present disclosure is not limited to the following embodiments and the present disclosure can be applied with appropriate modifications to the extent that the gist of the present disclosure is not altered. Combinations of two or more desired configurations among configurations described below are also included in the scope of the present disclosure.

### First Embodiment

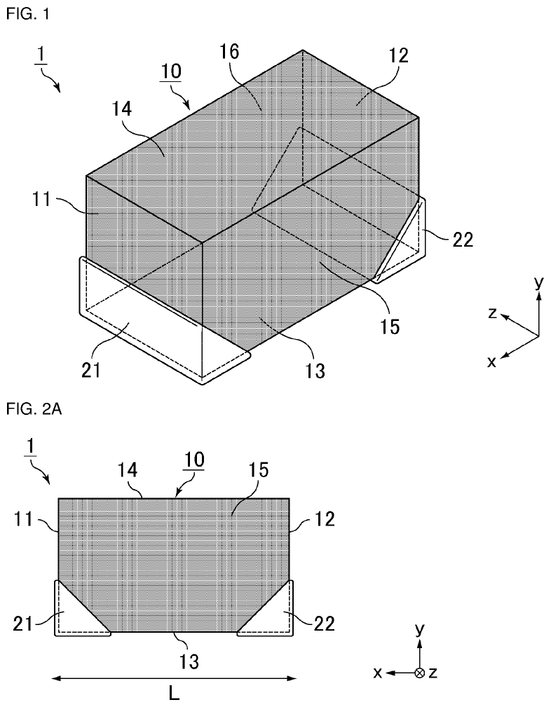

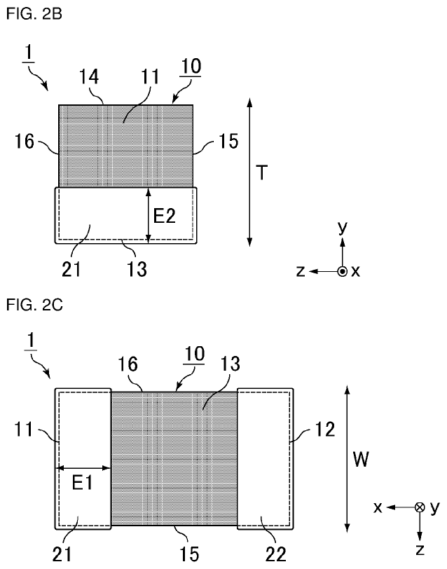

FIG. 1 is a perspective view schematically illustrating a multilayer coil component according to a First Embodiment of the present disclosure. FIG. 2A is a side view of the multilayer coil component illustrated in FIG. 1. FIG. 2B is a front view of the multilayer coil component illustrated in FIG. 1. FIG. 2C is a bottom view of the multilayer coil component illustrated in FIG. 1.

A multilayer coil component 1 illustrated in FIGS. 1, 2A, 2B, and 2C includes a multilayer body 10, a first outer electrode 21, and a second outer electrode 22. The multilayer body 10 has a substantially rectangular parallelepiped shape having six surfaces. The configuration of the multilayer body 10 will be described later, but the multilayer body 10 is formed by stacking a plurality of insulating layers on top of one another and has a coil thereinside. The first outer electrode 21 and the second outer electrode 22 are electrically connected to the coil.

In the multilayer coil component and the multilayer body of the present disclosure, a length direction, a height direction, and a width direction are respectively illustrated as an x direction, a y direction, and a z direction in FIG. 1. Here, the length direction (x direction), the height direction (y direction), and the width direction (z direction) are perpendicular to each other.

As illustrated in FIGS. 1, 2A, 2B, and 2C, the multilayer body 10 has a first end surface 11 and a second end surface 12, which face each other in the length direction (x direction), a first main surface 13 and a second main surface 14, which face each other in the height direction (y direction) perpendicular to the length direction, and a first side surface 15 and a second side surface 16, which face each other in the width direction (z direction) perpendicular to the length direction and the height direction.

Although not illustrated in FIG. 1, corner portions and edge portions of the multilayer body 10 are preferably rounded. The term “corner portion” refers to a part of the multilayer body where three surfaces intersect and the term “edge portion” refers to a part of the multilayer body where two surfaces intersect.

The first outer electrode 21 is arranged so as to cover part of the first end surface 11 of the multilayer body 10 as illustrated in FIGS. 1 and 2B and so as to extend from the first end surface 11 and cover part of the first main surface 13 of the multilayer body 10, as illustrated in FIGS. 1 and 2C. In FIG. 2B, the first outer electrode 21 covers a region of the first end surface 11 that includes the edge portion that intersects the first main surface 13, but does not cover a region of the first end surface 11 that includes the edge portion that intersects the second main surface 14. Therefore, the first end surface 11 is exposed in the region including the edge portion that intersects the second main surface 14. Although not illustrated in FIGS. 1 and 2B, the first outer electrode 21 may be disposed so as to cover the entirety of the first end surface 11. In this case, the first outer electrode 21 may cover the edge portion where the first end surface 11 and the second main surface 14 intersect. In addition, the first outer electrode 21 may additionally cover a portion of the second main surface 14, and in this case, the area of the second main surface 14 covered by the first outer electrode 21 is smaller than the area of the first main surface 13 covered by the first outer electrode 21.

In FIG. 2B, the height of the first outer electrode 21 in the portion covering the first end surface 11 of the multilayer body 10 is constant, but the shape of the first outer electrode 21 is not particularly limited. For example, the first outer electrode 21 may have an arch-like shape that increases in height from the ends toward the center on the first end surface 11 of the multilayer body 10. In addition, in FIG. 2C, the height of the first outer electrode 21 in the portion covering the first main surface 13 of the multilayer body 10 is constant, but the shape of the first outer electrode 21 is not particularly limited. For example, the first outer electrode 21 may have an arch-like shape that increases in length from the ends toward the center on the first main surface 13 of the multilayer body 10.

As illustrated in FIGS. 1 and 2A, the first outer electrode 21 may be additionally disposed so as to extend from the first end surface 11 and the first main surface 13 and cover part of the first side surface 15 and part of the second side surface 16. In this case, as illustrated in FIG. 2A, the parts of the first outer electrode 21 covering the first side surface 15 and the second side surface 16 may be formed in a diagonal shape relative to both the edge portion that intersects the first end surface 11 and the edge portion that intersects the first main surface 13. However, the first outer electrode 21 does not have to be disposed so as to cover part of the first side surface 15 and part of the second side surface 16. In FIGS. 1 and 2A, the shape of the part of the first outer electrode 21 covering the first side surface 15 of the multilayer body 10 is a right-angled triangle, but the shape of the first outer electrode 21 is not particularly limited. For example, on the first side surface 15 of the multilayer body 10, the boundary of the first outer electrode 21 spanning from the first end surface 11 to the first main surface 13 may be curved. In FIG. 1, the shape of the part of the first outer electrode 21 covering the second side surface 16 of the multilayer body 10 is a right-angled triangle, but the shape of the first outer electrode 21 is not particularly limited. For example, on the second side surface 16 of the multilayer body 10, the boundary of the first outer electrode 21 spanning from the first end surface 11 to the first main surface 13 may be curved.

The second outer electrode 22 is disposed so as to cover part of the second end surface 12 of the multilayer body 10 and so as to extend from the second end surface 12 and cover part of the first main surface 13 of the multilayer body 10. Similarly to the first outer electrode 21, the second outer electrode 22 covers a region of the second end surface 12 that includes the edge portion that intersects the first main surface 13, but does not cover a region of the second end surface 12 that includes the edge portion that intersects the second main surface 14. Therefore, the second end surface 12 is exposed in the region including the edge portion that intersects the second main surface 14. Although not illustrated, the second outer electrode 22 may be disposed so as to cover the entirety of the second end surface 12. In this case, the second outer electrode 22 may cover the edge portion where the second end surface 12 and the second main surface 14 intersect. In addition, the second outer electrode 22 may additionally cover a portion of the second main surface 14, and in this case, the area of the second main surface 14 covered by the second outer electrode 22 is smaller than the area of the first main surface 13 covered by the second outer electrode 22.

Similarly to the first outer electrode 21, the shape of the second outer electrode 22 is not particularly limited. For example, the second outer electrode 22 may have an arch-like shape that increases in height from the ends toward the center on the second end surface 12 of the multilayer body 10. In addition, the shape of the second outer electrode 22 is not particularly limited. For example, the second outer electrode 22 may have an arch-like shape that increases in length from the ends toward the center on the first main surface 13 of the multilayer body 10.

Similarly to the first outer electrode 21, the second outer electrode 22 may be additionally disposed so as to extend from the second end surface 12 and the first main surface 13 and cover part of the first side surface 15 and part of the second side surface 16. In this case, the parts of the second outer electrode 22 covering the first side surface 15 and the second side surface 16 may be formed in a diagonal shape relative to both the edge portion that intersects the second end surface 12 and the edge portion that intersects the first main surface 13. However, the second outer electrode 22 does not have to be disposed so as to cover part of the first side surface 15 and part of the second side surface 16. In addition, similarly to the first outer electrode 21, the shape of the part of the second outer electrode 22 covering the first side surface 15 of the multilayer body 10 is not particularly limited. For example, on the first side surface 15 of the multilayer body 10, the boundary of the second outer electrode 22 spanning from the second end surface 12 to the first main surface 13 may be curved. In addition, the shape of the part of the second outer electrode 22 covering the second side surface 16 of the multilayer body 10 is not particularly limited. For example, on the second side surface 16 of the multilayer body 10, the boundary of the second outer electrode 22 spanning from the second end surface 12 to the first main surface 13 may be curved.

Since the first outer electrode 21 and the second outer electrode 22 are disposed in the above described manner, when the multilayer coil component 1 is to be mounted on a substrate, out of the first main surface 13 and the second main surface 14 of the multilayer body 10, the first main surface 13 for which the sum of the areas where the first and second outer electrodes are formed is larger is used as the mounting surface.

Although the size of the multilayer coil component of the present disclosure is not particularly limited, the multilayer coil component is preferably the 0603 size or the 0402 size.

In the case where the multilayer coil component of the present disclosure is the 0603 size, the length of the multilayer coil component including the dimensions of the first outer electrode and the second outer electrode (length indicated by double-headed arrow L in FIG. 2A) is preferably greater than or equal to 0.57 mm and less than or equal to 0.63 mm (i.e., from 0.57 mm to 0.63 mm), and the width of the multilayer coil component including the dimensions of the first outer electrode and the second outer electrode (length indicated by double-headed arrow W in FIG. 2C) is preferably greater than or equal to 0.27 mm and less than or equal to 0.33 mm (i.e., from 0.27 mm to 0.33 mm).

In the case where the multilayer coil component of the present disclosure is the 0603 size, the height of the multilayer coil component including the dimensions of the first outer electrode and the second outer electrode (length indicated by double-headed arrow T in FIG. 2B) is preferably greater than or equal to 0.27 mm and less than or equal to 0.33 mm (i.e., from 0.27 mm to 0.33 mm).

In the case where the outer electrodes cover only parts of the end surfaces, the height of the part of the first outer electrode covering the first end surface of the multilayer body may be greater than or equal to 3/10 and less than or equal to ¾ (i.e., from 3/10 to ¾) the height of the first end surface or may be greater than or equal to ⅓ and less than or equal to ⅔ (i.e., from ⅓ to ⅔) the height of the first end surface. Similarly, the height of the part of the second outer electrode that covers the second end surface of the multilayer body may be greater than or equal to 3/10 and less than or equal to ¾ (i.e., from 3/10 to ¾) the height of the second end surface or may be greater than or equal to ⅓ and less than or equal to ⅔ (i.e., from ⅓ to ⅔) the height of the second end surface. When the height of the first outer electrode and the height of the second outer electrode are greater than or equal to 3/10 of the height of the first end surface and the height of the second end surface, respectively, the adhesive force between solder and the first end surface 11 and solder and the second end surface 12 can be made relatively strong when mounting the multilayer coil component on a substrate using solder. In addition, when the height of the first outer electrode and the height of the second outer electrode are greater than or equal to ⅓ of the height of the first end surface and the height of the second end surface, respectively, the adhesive force between the solder and the first end surface 11 and the second end surface 12 can be made even stronger. When the height of the first outer electrode and the height of the second outer electrode are less than or equal to ¾ of the height of the first end surface and the height of the second end surface, respectively, stray capacitances caused by the outer electrodes can be relatively reduced. When the height of the first outer electrode and the height of the second outer electrode are less than or equal to ⅔ of the height of the first end surface and the height of the second end surface, respectively, stray capacitances caused by the outer electrodes can be even further reduced.

In the case where the multilayer coil component of the present disclosure is the 0603 size, the length of the part of the first outer electrode that covers the first main surface of the multilayer body (length indicated by double-headed arrow E1 in FIG. 2C) is preferably greater than or equal to 0.12 mm and less than or equal to 0.22 mm (i.e., from 0.12 mm to 0.22 mm). Similarly, the length of the part of the second outer electrode that covers the first main surface of the multilayer body is preferably greater than or equal to 0.12 mm and less than or equal to 0.22 mm (i.e., from 0.12 mm to 0.22 mm). Here, the length of the part of the first outer electrode covering the first main surface of the multilayer body and the length of the part of the second outer electrode covering the first main surface of the multilayer body may be measured as the maximum lengths in the length direction (x direction) (i.e., lengths including the outer portions of the multilayer body) when the first main surface of the multilayer body is viewed in plan view. Furthermore, in the case where the length of the part of the first outer electrode that covers the first main surface of the multilayer body and the length of the part of the second outer electrode that covers the first main surface of the multilayer body are not constant, it is preferable that the lengths of the longest parts lie within the above-described range.

In the case where the multilayer coil component of the present disclosure is the 0603 size, the height of the part of the first outer electrode that covers the first end surface of the multilayer body (length indicated by double-headed arrow E2 in FIG. 2B) is preferably greater than or equal to 0.1 mm and less than or equal to 0.2 mm (i.e., from 0.1 mm to 0.2 mm). Similarly, the height of the part of the second outer electrode that covers the second end surface of the multilayer body is preferably greater than or equal to 0.1 mm and less than or equal to 0.2 mm (i.e., from 0.1 mm to 0.2 mm). Here, the height of the part of the first outer electrode that covers the first end surface of the multilayer body and the height of the part of the second outer electrode that covers the second end surface of the multilayer body may be measured as the maximum lengths in the height direction (y direction) (i.e., lengths including the outer portions of the multilayer body) when the first end surface and the second end surface of the multilayer body are viewed in plan view. In the case where the height of the part of the first outer electrode that covers the first end surface of the multilayer body and the height of the part of the second outer electrode that covers the second end surface of the multilayer body are not constant, it is preferable that the heights of the highest parts thereof lie within the above-described range.

In the case where the multilayer coil component of the present disclosure is the 0402 size, the length of the multilayer coil component including the dimensions of the first outer electrode and the second outer electrode is preferably greater than or equal to 0.38 mm and less than or equal to 0.42 mm (i.e., from 0.38 mm to 0.42 mm), and the width of the multilayer coil component including the dimensions of the first outer electrode and the second outer electrode is preferably greater than or equal to 0.18 mm and less than or equal to 0.22 mm (i.e., from 0.18 mm to 0.22 mm).

In the case where the multilayer coil component of the present disclosure is the 0402 size, the height of the multilayer coil component including the dimensions of the first outer electrode and the second outer electrode is preferably greater than or equal to 0.18 mm and less than or equal to 0.22 mm (i.e., from 0.18 mm to 0.22 mm).

In the case where the multilayer coil component of the present disclosure is the 0402 size, the length of the part of the first outer electrode that covers the first main surface of the multilayer body is preferably greater than or equal to 0.08 mm and less than or equal to 0.15 mm (i.e., from 0.08 mm to 0.15 mm). Similarly, the length of the part of the second outer electrode that covers the first main surface of the multilayer body is preferably greater than or equal to 0.08 mm and less than or equal to 0.15 mm (i.e., from 0.08 mm to 0.15 mm).

In the case where the multilayer coil component of the present disclosure is the 0402 size, the height of the part of the first outer electrode that covers the first end surface of the multilayer body is preferably greater than or equal to 0.06 mm and less than or equal to 0.13 mm (i.e., from 0.06 mm to 0.13 mm). Similarly, the height of the part of the second outer electrode that covers the second end surface of the multilayer body is preferably greater than or equal to 0.06 mm and less than or equal to 0.13 mm (i.e., from 0.06 mm to 0.13 mm).

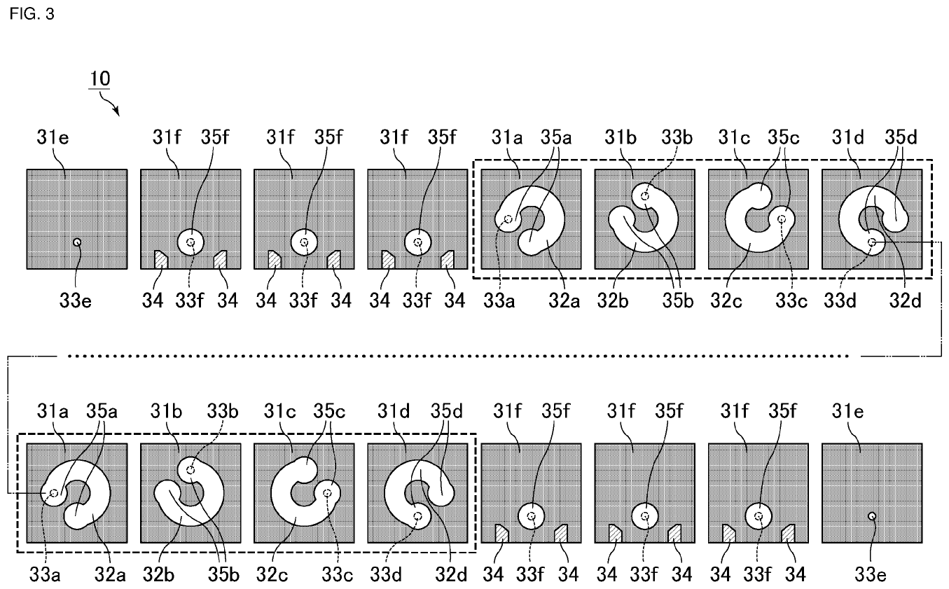

FIG. 3 is an exploded plan view schematically illustrating an example of the multilayer body of the multilayer coil component illustrated in FIG. 1.

As illustrated in FIG. 3, the multilayer body 10 is formed by stacking a plurality of insulating layers 31a, 31b, 31c, 31d, 31e, and 31f in the length direction (x direction). The direction in which the plurality of insulating layers of the multilayer body are stacked is called the stacking direction.

Coil conductors 32a, 32b, 32c, and 32d and via conductors 33a, 33b, 33c, and 33d are respectively provided on and in the insulating layers 31a, 31b, 31c, and 31d. Lands 35a, 35b, 35c, and 35d are respectively included in the coil conductors 32a, 32b, 32c, and 32d. Via conductors 33e are provided in the insulating layers 31e. Via conductors 33f, lands 35f, and mark conductor patterns 34 are provided on and in the insulating layers 31f.

The coil conductors 32a, 32b, 32c, and 32d are respectively provided on main surfaces of the insulating layers 31a, 31b, 31c, and 31d and are stacked together with the insulating layers 31a, 31b, 31c, 31d, 31e, and 31f. In FIG. 3, each coil conductor is shaped so as to extend through ¾ of a turn and the four insulating layers 31a, 31b, 31c, and 31d are repeatedly stacked in this order as one unit (three turns). In addition, the lands 35a, 35b, 35c, and 35d are respectively provided at both end portions of the coil conductors 32a, 32b, 32c, and 32d.

The via conductors 33a, 33b, 33c, 33d, 33e, and 33f are respectively provided so as to penetrate through the insulating layers 31a, 31b, 31c, 31d, 31e, and 31f in the thickness direction (x direction).

The lands 35f are provided directly on top of the via conductors 33f. The lands 35a, 35b, 35c, 35d, and 35f are preferably slightly larger than the line widths of the coil conductors 32a, 32b, 32c, and 32d, excluding the lands 35a, 35b, 35c, and 35d.

The mark conductor patterns 34 are provided on a main surface of each insulating layer 31f. In FIG. 3, the mark conductor patterns 34 are provided at two locations on a main surface of each insulating layer 31f, and both mark conductor patterns 34 are in contact with the outer peripheral edge of the insulating layer 31f.

The thus-configured insulating layers 31a, 31b, 31c, 31d, 31e, and 31f are stacked on top of one another in the x direction. Thus, the coil conductors 32a, 32b, 32c, and 32d are electrically connected to each other by the via conductors 33a, 33b, 33c, and 33d. As a result, a solenoid coil having a coil axis that is parallel to the x direction is formed inside the multilayer body 10.

In addition, the via conductors 33e form connection conductors inside the multilayer body 10 together with the via conductors 33f and the lands 35f and are exposed at both end surfaces of the multilayer body 10. In other words, each connection conductor includes the via conductor 33e, the via conductor 33f, and the land 35f. As described below, each connection conductor is either a first connection conductor connected between the first outer electrode 21 and the coil conductor 32a facing the first outer electrode 21 inside the multilayer body 10, or a second connection conductor connected between the second outer electrode 22 and the coil conductor 32d facing the second outer electrode 22 inside the multilayer body 10.

The mark conductor patterns 34 have a planar shape extending along a plane perpendicular to the axial direction of the coil. The mark conductor patterns 34 are exposed at the first main surface 13 of the multilayer body 10, and serve as discrimination marks. For convenience, in the present disclosure, when a feature is possessed by at least one mark conductor pattern 34, it may be said that the feature is possessed by a discrimination mark. For example, when a mark conductor pattern constituting a discrimination mark has a cutout part, it may be said that the discrimination mark has the cutout part.

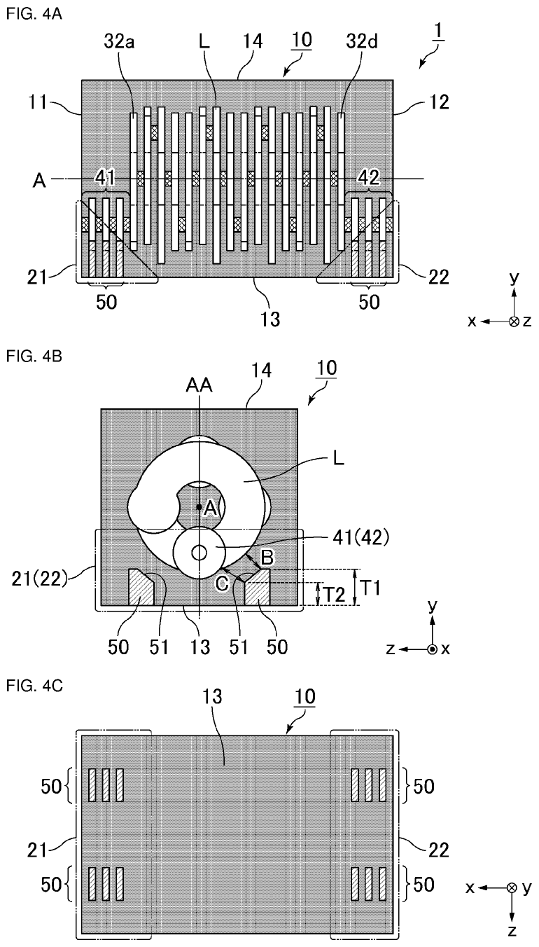

FIG. 4A is a side view schematically illustrating in a see-through manner an example of the internal structure of the multilayer body of the multilayer coil component according to the First Embodiment of the present disclosure. FIG. 4B is a front view schematically illustrating in a see-through manner an example of the internal structure of the multilayer body of the multilayer coil component according to the First Embodiment of the present disclosure. FIG. 4C is a bottom view schematically illustrating an example of a first main surface of the multilayer body of the multilayer coil component according to the First Embodiment of the present disclosure. FIG. 4B illustrates a plan view of the multilayer body from the side where the first outer electrode (or the second outer electrode) is located in the axial direction of the coil.

As illustrated in FIG. 4A, in the multilayer coil component 1, the stacking direction of the multilayer body 10 and the axial direction of a coil L (coil axis A of coil L is illustrated in FIG. 4A) are parallel to the first main surface 13, which is the mounting surface.

A first connection conductor 41 is connected in a straight line between the part of the first outer electrode 21 covering the first end surface 11 and the coil conductor 32a facing that part of the first outer electrode 21 inside the multilayer body 10. Similarly, a second connection conductor 42 is connected in a straight line between the part of the second outer electrode 22 covering the second end surface 12 and the coil conductor 32d facing that part of the second outer electrode 22 inside the multilayer body 10. By connecting the first connection conductor 41 and the second connection conductor 42 from the coil to the outer electrodes in straight lines, lead out parts can be simplified and the radio-frequency characteristics can be improved.

Via conductors constituting the connection conductors preferably overlap in plan view in the stacking direction (i.e., when viewed in plan view in the axial direction of the coil), but the via conductors constituting the connection conductors do not have to be precisely aligned in a straight line.

As illustrated in FIG. 4B, the first connection conductor 41 overlaps the coil conductors constituting the coil L when viewed in plan view in the stacking direction, and as illustrated in FIG. 4A, the first connection conductor 41 is located closer to the first main surface 13, which is the mounting surface, than the coil axis A of the coil L is. Similarly, the second connection conductor 42 overlaps the coil conductors constituting the coil L when viewed in plan view in the stacking direction, and the second connection conductor 42 is located closer to the first main surface 13, which is the mounting surface, than the coil axis A of the coil L is.

In FIGS. 4A and 4B, the first connection conductor 41 and the second connection conductor 42 are both provided at positions closest to the first main surface 13 out of positions overlapping the coil conductors constituting the coil L when viewed in plan view in the stacking direction. However, the first connection conductor 41 may be provided at any position so long as the first connection conductor 41 overlaps the coil conductors constituting the coil L when viewed in plan view in the stacking direction and is connected to the first outer electrode 21. Similarly, the second connection conductor 42 may be provided at any position so long as the second connection conductor 42 overlaps the coil conductors constituting the coil L when viewed in plan view in the stacking direction and is connected to the second outer electrode 22. In addition, in FIG. 4A, the first connection conductor 41 and the second connection conductor 42 overlap each other when viewed in plan view in the stacking direction, but the first connection conductor 41 and the second connection conductor 42 do not have to overlap each other.

As illustrated in FIG. 4B, the coil conductors constituting the coil L preferably overlap each other when viewed in plan view in the stacking direction. In addition, the coil L preferably has a circular shape when viewed in plan view in the stacking direction. Note that the coil L includes lands, and in this case, the shape of the coil L is defined as the shape of the coil L excluding the lands.

Discrimination marks 50 are provided at locations on the surface of the multilayer body 10, excluding the first end surface 11 and the second end surface 12, where the first outer electrode 21 or the second outer electrode 22 are disposed. In FIGS. 4A and 4C, the discrimination marks 50 are provided on the first main surface 13 of the multilayer body 10. Although not illustrated, the location where the discrimination marks 50 are disposed is not limited to the first main surface 13 so long as the location is where the first outer electrode 21 or the second outer electrode 22 is disposed. For example, the location where the discrimination marks 50 are disposed may be on the first side surface 15, the second side surface 16, or the second main surface 14. The discrimination mark 50 provided at the location where the first outer electrode 21 is disposed is referred to as a first discrimination mark, and the discrimination mark 50 provided at the location where the second outer electrode 22 is disposed is referred to as a second discrimination mark. By providing discrimination marks on the surface of the multilayer body, it is easy to determine where the outer electrodes are to be formed. Therefore, a discrimination process using sensors and so on can be automated.

The discrimination marks are composed of mark conductor patterns provided on at least one insulating layer so as to be exposed at the first main surface. In other words, the discrimination marks extend from the inside of the multilayer body and are exposed at a surface of the multilayer body other than the end surfaces of the multilayer body. In addition, since the discrimination marks are composed of mark conductor patterns provided on the insulating layers, the discrimination marks can be easily formed. This is because parts of the conductor patterns can be caused to be exposed from the first main surface of the multilayer body 10 by providing the conductor patterns so as to contact the outer peripheral edges of the insulating layers. However, it is sufficient that “exposed” here means exposed at a surface of the multilayer body 10. For example, suppose that the first discrimination mark and the second discrimination mark are respectively covered by the formation of the first outer electrode and the second outer electrode, in this case, the first discrimination mark and the second discrimination mark are still exposed at the surface of the multilayer body 10. Therefore, part of a first mark conductor pattern for forming the first discrimination mark is in contact with the inner surface of the first outer electrode 21. Therefore, part of a second mark conductor pattern for forming the second discrimination mark is in contact with the inner surface of the second outer electrode 22.

In the example illustrated in FIG. 4C, the discrimination marks 50 are provided on three insulating layers that overlap the first outer electrode 21 (refer to insulating layers 31f in FIG. 3) and on three insulating layers that overlap the second outer electrode 22 (refer to insulating layers 31f in FIG. 3). The discrimination marks 50 are exposed at the first main surface 13 of the multilayer body 10 and are electrically connected to the first outer electrode 21 and the second outer electrode 22.

The discrimination marks may be provided on only one insulating layer, but the discrimination marks are preferably provided on at least two insulating layers. In addition, the first discrimination mark may include only one first mark conductor pattern, but preferably includes two or more first mark conductor patterns provided so as to be spaced apart from each other. Similarly, the second discrimination mark may include only one second mark conductor pattern, but preferably includes two or more second mark conductor patterns provided so as to be spaced apart from each other.

A discrimination mark may be provided only at the location where either the first outer electrode or the second outer electrode is disposed, but is preferably provided at both locations where the first outer electrode and the second outer electrode are disposed. In other words, the first discrimination mark and the second discrimination mark are preferably provided. In this case, the number of first mark conductor patterns constituting the first discrimination mark at the location where the first outer electrode is disposed and the number of second mark conductor patterns constituting the second discrimination mark at the location where the second outer electrode is disposed may be the same as each other or different from each other.

Thus, the discrimination marks are preferably provided on at least one insulating layer in contact with the first outer electrode and on at least one insulating layer in contact with the second outer electrode.

As illustrated in FIG. 4B, a cutout part 51 is provided in each discrimination mark 50 at a location opposite the coil axis A of the coil L when viewed in plan view in the axial direction of the coil L. Therefore, even if the discrimination marks 50 are increased in size (even if increased size in the height direction), an increase in stray capacitance between the outer electrodes electrically connected to the discrimination marks 50 and the coil or connection conductors (in particular, the via conductors and lands on the same layers as the discrimination marks 50 in the case illustrated in FIG. 4B) can be suppressed. The size (dimension in height direction) of the discrimination marks 50 can be made large enough that the discrimination marks 50 are exposed at the first main surface 13 of the multilayer body 10 even if cutting misalignment occurs for the multilayer body block.

Thus, each discrimination mark is shaped such that a part of the discrimination mark facing a conductor formed on the same insulating layer (first connection conductor 41 and second connection conductor 42 in FIGS. 4A and 4B) is missing in order to maintain the distance from the conductor.

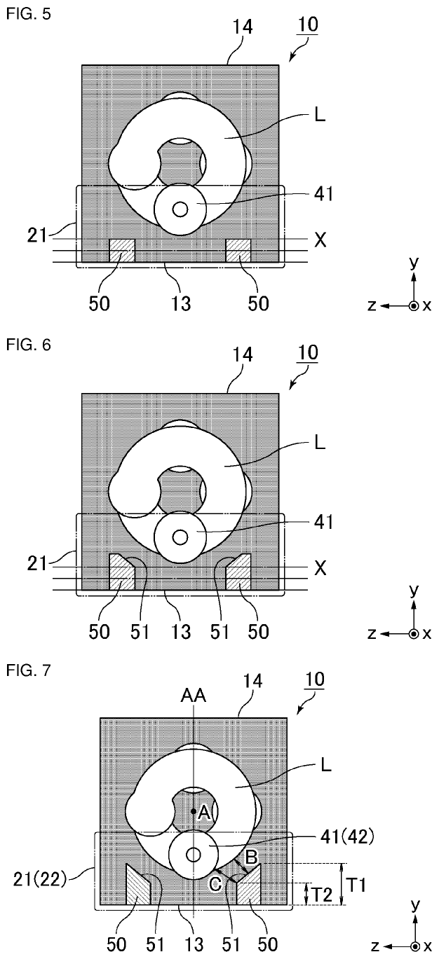

FIG. 5 is a front view schematically illustrating in a see-through manner an example of the internal structure of a multilayer body block of a multilayer coil component according to a comparative example of the present disclosure in which the positional relationship between the multilayer body block and cutting lines is illustrated.

As Illustrated in FIG. 5, in the multilayer coil component according to the comparative example, when viewed in plan view in the axial direction of the coil L, the discriminations mark 50 are rectangular in shape, and therefore if cutting misalignment occurs and a cutting line (see each single-dot chain line in FIG. 5) is shifted, the discrimination marks 50 might not be clearly exposed in the cross section (see single-dot chain line X in FIG. 5). In such a case, the discrimination marks 50 would appear in a blurred manner on the surface of the multilayer body 10, and as a result, it might be the case that the effect of the discrimination marks 50 cannot be sufficiently realized, i.e., the locations where the outer electrode are to be formed cannot be determined. On the other hand, although not illustrated, if the rectangular discrimination marks 50 are increased in size in the height direction (y direction) of the multilayer body 10 in order to accommodate cutting misalignment, stray capacitances generated between the coil L and the discrimination marks 50 increase, and the radio-frequency characteristics of the coil are degraded.

FIG. 6 is a front view corresponding to FIG. 4B and illustrates the positional relationship between the multilayer body block and cutting lines.

In contrast, in this embodiment, as illustrated in FIG. 6, the cutout part 51 is provided in each discrimination mark 50 at a location opposite the coil axis A of the coil L, and therefore the discrimination marks 50 can be increased in size in the height direction (y direction) of the multilayer body 10 while suppressing stray capacitances generated between the coil L and the discrimination marks 50. Therefore, even if cutting misalignment occurs and the cutting line (see each single-dot chain line in FIG. 6) is shifted, the discrimination marks 50 are clearly exposed in the cross section (see single-dot chain line X in FIG. 6). Therefore, the discrimination marks 50 are clearly visible on the surface of the multilayer body 10, and as a result, the locations where the outer electrodes are to be formed can be reliably determined.

It is preferable that at least one layer of discrimination mark (one discrimination mark) be provided on an insulating layer where the first connection conductor or the second connection conductor is formed. In addition, the first discrimination mark preferably includes a first mark conductor pattern formed in a cross section of the multilayer body 10 that is perpendicular to the coil axis A of the coil L and in which the first connection conductor is formed. In other words, in a certain cross section of the multilayer body 10 perpendicular to the coil axis A of the coil L, it is preferable that both the first connection conductor and the first mark conductor pattern are exposed. Similarly, the second discrimination mark preferably includes a second mark conductor pattern formed in a cross section of the multilayer body 10 that is perpendicular to the coil axis A of the coil L and in which the second connection conductor is formed. As illustrated in FIG. 4A, it is more preferable that the discrimination marks 50 be provided on the insulating layers on which the first connection conductor 41 is formed (refer to insulating layers 31f in FIG. 3) and on the insulating layers on which the second connection conductor 42 is formed (refer to insulating layers 31f in FIG. 3).

FIG. 7 is a front view schematically illustrating in a see-through manner another example of the internal structure of the multilayer body of the multilayer coil component according to the First Embodiment of the present disclosure in which a First Modification of a cutout part is illustrated. FIG. 7 illustrates a plan view of the multilayer body from the side where the first outer electrode (or second outer electrode) is located in the axial direction of the coil.

As illustrated in FIGS. 4B and 7, the cutout part 51 of each discrimination mark 50 may have a linear shape. This allows the discrimination marks 50 to be effectively made larger (longer in the height direction) while suppressing an increase in stray capacitance. The discrimination marks 50 may have a pentagonal shape, as illustrated in FIG. 4B, or a quadrangular shape (for example, trapezoidal), as illustrated in FIG. 7.

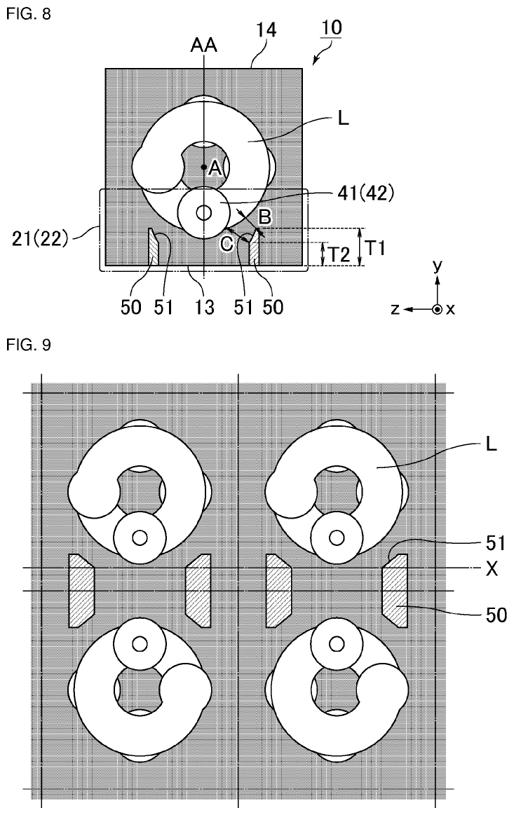

FIG. 8 is a front view schematically illustrating in a see-through manner yet another example of the internal structure of the multilayer body of the multilayer coil component according to the First Embodiment of the present disclosure in which a Second Modification of a cutout part is illustrated. FIG. 8 illustrates a plan view of the multilayer body from the side where the first outer electrode (or second outer electrode) is located in the axial direction of the coil.

As illustrated in FIG. 8, the discrimination marks 50 may be shaped such that the cutout parts 51 follow the outer periphery of the first connection conductor 41 (preferably the land 35f closest to the discrimination marks 50) when the multilayer body 10 is viewed in plan view in the axial direction of the coil L. Similarly, the discrimination marks 50 may be shaped such that the cutout parts 51 follow the outer periphery of the second connection conductor 42 (preferably the land 35f closest to the discrimination marks 50) when the multilayer body 10 is viewed in plan view in the axial direction of the coil L. This also allows the discrimination marks 50 to be effectively made larger (longer in the height direction) while suppressing an increase in stray capacitance. In this case, the cutout parts 51 may have a curved shape such as an arc shape.

When each discrimination mark is composed of a plurality of mark conductor patterns, the plurality of cutout parts provided in those mark conductor patterns may all have the same shape, or the plurality of mark conductor patterns may contain cutout parts having different shapes from each other.

As illustrated in FIGS. 4B, 7, and 8, the discrimination marks 50 are preferably symmetrically provided at two locations spaced apart from each other with respect to an axis AA perpendicular to the first main surface 13 when viewed in plan view in the axial direction of the coil L. Thus, the number of discrimination marks 50 is doubled, and therefore the effect of the discrimination marks 50 is more reliably realized. The axis AA passes extends along the coil axis A of the coil L.

Although the size of the discrimination marks is not particularly limited, as illustrated in FIGS. 4B, 7, and 8, in the case where the discrimination marks are provided at positions shifted from the axis AA perpendicular to the first main surface 13, if the dimensions of the discrimination marks in the height direction of the multilayer body are denoted by T1 for the dimension farther from the axis AA and T2 for the dimension nearer the axis AA, T1 is larger than T2. T1 corresponds to the distance from the first main surface 13 of the highest position in the mark conductor pattern when the multilayer coil component is viewed in plan view in the axial direction of the coil L with the second main surface 14 being on an upper side and the first main surface 13 being on a lower side. T2 corresponds to the distance from the first main surface 13 of the lowest position of the cutout part 51 of the mark conductor pattern when the multilayer coil component is viewed in plan view in the axial direction of the coil L with the second main surface 14 being on an upper side and the first main surface 13 being on a lower side. As illustrated in FIGS. 4B, 7, and 8, when the multilayer coil component is viewed in plan view in the axial direction of the coil L with the second main surface 14 being on an upper side and the first main surface 13 being on a lower side, T1 may be larger than the distance (shortest distance) of the coil L from the first main surface 13 and the distance (shortest distance) of the first connection conductor 41 or the second connection conductor 42 from the first main surface 13, and T2 may be smaller than the distance (shortest distance) of the coil L from the first main surface 13 and the distance (shortest distance) of the first connection conductor 41 or the second connection conductor 42 from the first main surface 13. T1 may be, for example, less than or equal to 10 μm as the dimension after firing. A shortest distance B between the coil L and each discrimination mark and a shortest distance C between the first connection conductor 41 or the second connection conductor 42 and the discrimination mark may both be greater than or equal to 5 μm, or greater than or equal to 10 μm. If the shortest distance B between the coil L and the discrimination mark is greater than or equal to 5 μm, an increase in stray capacitance can be suppressed and radio-frequency characteristics are improved. If the shortest distance B is greater than or equal to 10 μm, an increase in stray capacitance can be further suppressed and the radio-frequency characteristics are further improved. A method for measuring the shortest distances B and C involves measuring the distance between the closest parts of the coil or connection conductor and the discrimination mark when looking at a cross section of the multilayer coil component perpendicular to the stacking direction.

In the example illustrated in FIG. 4C, three discrimination marks 50 are provided in each of four areas including the corners of the first main surface 13. One or two discrimination marks may be provided in each of the four areas, or four or more discrimination marks may be provided in each of the four areas. When discrimination marks are provided in a plurality of areas, the same number of discrimination marks or different numbers of discrimination marks may be contained in each area.

The width (dimension in the width direction of the multilayer body) of the lines constituting the discrimination marks is not particularly limited, but is preferably greater than or equal to 0.04 mm and less than or equal to 0.1 mm (i.e., from 0.04 mm to 0.1 mm). In addition, the thickness (dimension in the length direction of the multilayer body) and shape of the lines are also not particularly limited.

Hereafter, an example of a method of manufacturing the multilayer coil component according to the First Embodiment of the present disclosure will be described.

First, ceramic green sheets, which will form the insulating layers, are manufactured. For example, an organic binder such as a polyvinyl butyral resin, an organic solvent such as ethanol or toluene, and a dispersant are added to a ferrite raw material and kneaded to form a slurry. After that, magnetic sheets having a thickness of around 12 μm are obtained using a method such as a doctor blade technique.

As a ferrite raw material, for example, iron, nickel, zinc and copper oxide raw materials are mixed together and calcined at 800° C. for 1 hour, pulverized using a pole mill, and dried, and a Ni—Zn—Cu ferrite raw material (oxide mixed powder) having an average particle diameter of about 2 μm can be obtained.

As a ceramic green sheet material, which will form the insulating layers, for example, a magnetic material such as a ferrite material, a nonmagnetic material such as a glass ceramic material, or a mixed material obtained by mixing a magnetic material and a nonmagnetic material can be used. When manufacturing ceramic green sheets using a ferrite material, in order to obtain a high L value (inductance), it is preferable to use a ferrite material having a composition consisting of Fe₂O₃ at 40 mol % to 49.5 mol %, ZnO at 5 mol % to 35 mol %, CuO at 4 mol % to 12 mol %, and the remainder consisting of NiO and trace amounts of additives (including inevitable impurities).

Via holes having a diameter of around 20 μm to 30 μm are formed by subjecting the manufactured ceramic green sheets to prescribed laser processing. Using a Ag paste on specific sheets having via holes, coil sheets are formed by filling the via holes and screen-printing and drying coil-looping conductor patterns (coil conductors) having a thickness of around 11 μm and shaped so as to extend through ¾ of a turn. Furthermore, coil sheets in which only via conductors making up part of connection conductors are formed or coil sheets in which only via conductors and land portions are formed are obtained in the substantially the same way. These coil sheets without printed coil conductors may be specifically referred to as via sheets.

The coil sheets are stacked so that a coil having a coil axis extending in a direction parallel to the mounting surface after cutting is formed inside the multilayer body. In addition, via sheets, in which via conductors that will make up the connection conductors are formed, are stacked above and below the coil sheets. At least one via sheet is a mark via sheet on which a mark conductor pattern is formed.

FIG. 9 is a front view schematically illustrating an example of a step of cutting a multilayer body block of the multilayer coil component according to the First Embodiment of the present disclosure.

Stacked coil sheets and via sheets are subjected to thermal pressure bonding to obtain a multilayer body block having a thickness of around 0.67 mm. Then, the multilayer body block is cut along cutting lines (single-dot chain lines in FIG. 9) to obtain individual chips having chip dimensions of a length of 0.67 mm, a width of 0.34 mm, and a height of 0.34 mm, as illustrated in FIG. 9. At this time, even if cutting misalignment occurs and the cutting lines are shifted (see, for example, a single-dot chain line X in FIG. 9), the discrimination marks 50 are clearly exposed in the cross section even for chips cut to be smaller than the standard size (the top two in FIG. 9) because the discrimination marks 50 are provided with the cutout parts 51. The individual chips may be processed using a rotary barrel in order to round the corner portions and edge portions thereof.

Binder removal and firing is performed at a predetermined temperature and for a predetermined period of time, and fired bodies (multilayer bodies) having a built-in coil are obtained.

The chips are dipped at an angle in a layer obtained by spreading Ag paste to a predetermined thickness and then baked to form a base electrode of an outer electrode on four surfaces (a main surface, an end surface, and both side surfaces) of the multilayer body. In the above-described method, the base electrode can be formed in one go in contrast to the case where the base electrode is formed separately on the main surface and the end surface of the multilayer body in two steps.

Formation of the outer electrodes is completed by sequentially forming a Ni film and a Sn film having predetermined thicknesses on the base electrodes by performing plating.

Another method of forming the outer electrodes is, for example, by dipping a brush or another tool into Ag paste and applying the brush to the areas where the outer electrodes are to be formed. This formation method enables the shape of the outer electrodes to be manipulated relatively easily compared to the method in which the outer electrodes are formed by dipping the multilayer body. For example, an outer electrode can be formed that covers part of an end surface and part of a main surface, but not both side surfaces. The multilayer coil component according to the First Embodiment of the present disclosure can be manufactured as described above.

### Second Embodiment

This embodiment differs from the First Embodiment in that the discrimination marks are also provided on insulating layers where coil conductors are formed. Therefore, similarly to the multilayer coil component of the First Embodiment, a multilayer coil component of this embodiment includes a multilayer body, a first outer electrode, and a second outer electrode, as illustrated in FIGS. 1, 2A, 2B, and 2C.

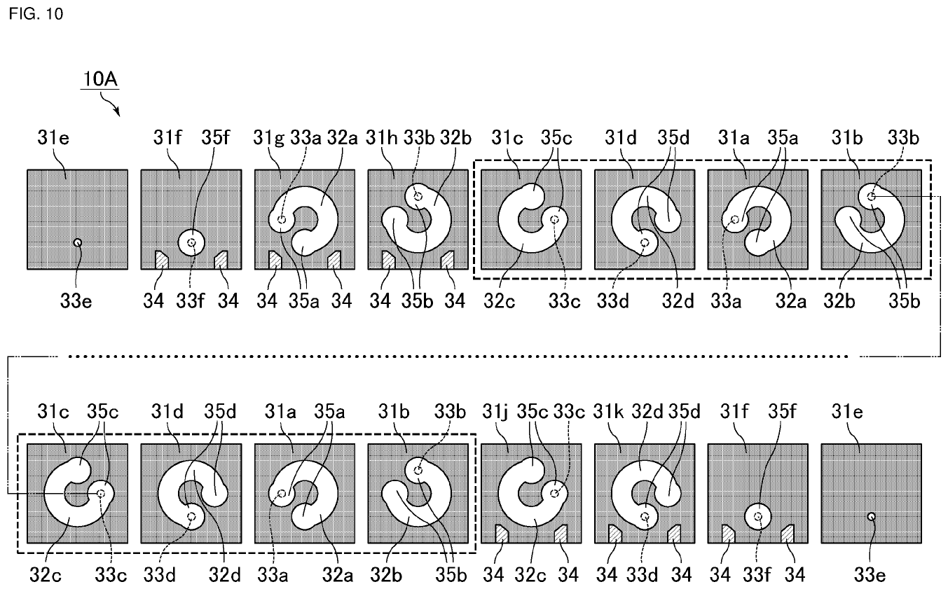

FIG. 10 is an exploded plan view schematically illustrating an example of a multilayer body of a multilayer coil component according to a Second Embodiment of the present disclosure.

As illustrated in FIG. 10, a multilayer body 10A of a multilayer coil component 1A of this embodiment includes a plurality of insulating layers 31a, 31b, 31c, 31d, 31e, 31f, 31g, 31h, 31j, and 31k stacked in the length direction (x direction).

The insulating layers 31a, 31b, 31c, 31d, 31e, and 31f are as described in the First Embodiment. The insulating layers 31g, 31h, 31j, and 31k are respectively provided with coil conductors 32a, 32b, 32c, and 32d, via conductors 33a, 33b, 33c, and 33d, and mark conductor patterns 34. Lands 35a, 35b, 35c, and 35d, which are respectively connected to the via conductors 33a, 33b, 33c, and 33d, are provided on the main surfaces of the insulating layers 31g, 31h, 31j, and 31k, respectively. These lands 35a, 35b, 35c, and 35d are respectively included in the coil conductors 32a, 32b, 32c, and 32d.

In this embodiment as well, each coil conductor is shaped so as to extend through ¾ of a turn, and four insulating layers are repeatedly stacked as one unit (3 turns) in the order of the insulating layers 31c, 31d, 31a, and 31b.

The mark conductor patterns 34 are provided on the main surfaces of the insulating layers 31g, 31h, 31j, and 31k in addition to the insulating layers 31f. In FIG. 10, the mark conductor patterns 34 are provided at two locations on the main surface of each insulating layer, and both mark conductor patterns 34 touch the outer peripheral edge of the insulating layer.

The insulating layers 31a, 31b, 31c, 31d, 31e, 31f, 31g, 31h, 31j, and 31k configured as described above are stacked in the x direction. Thus, the coil conductors 32a, 32b, 32c, and 32d are electrically connected to each other by the via conductors 33a, 33b, 33c, and 33d. As a result, a solenoid coil having a coil axis parallel to the x direction is formed inside the multilayer body 10A.

In addition, the via conductors 33e form connection conductors inside the multilayer body 10A together with the via conductors 33f and the lands 35f and are exposed at both end surfaces of the multilayer body 10A. In other words, each connection conductor includes the via conductor 33e, the via conductor 33f, and the land 35f. Each connection conductor is either a first connection conductor connected between the first outer electrode 21 and the coil conductor 32a facing the first outer electrode 21 inside the multilayer body 10A, or a second connection conductor connected between the second outer electrode 22 and the coil conductor 32d facing the second outer electrode 22 inside the multilayer body 10A.

In addition, the mark conductor patterns 34 have a planar shape extending along a plane perpendicular to the axial direction of the coil. The mark conductor patterns 34 are exposed at the first main surface 13 of the multilayer body 10A, and serve as discrimination marks.

In this embodiment, the mark conductor patterns 34 are provided not only on the insulating layers 31f where the via conductors 33f for forming the connection conductors are provided, but also on the insulating layers 31g, 31h, 31j, and 31k where the coil conductors 32a, 32b, 32c and 32d are provided.

Thus, at least one layer of discrimination mark (one discrimination mark) may be provided on an insulating layer on which a coil conductor is formed. In this case, a discrimination mark is preferably provided on an insulating layer on which a coil conductor positioned at one end or the other end (outermost), out of multiple coil conductors, is formed, and it is more preferable to provide the discrimination marks on insulating layers on which coil conductors positioned at one end and the other end (outermost) are formed. In addition, the first discrimination mark preferably includes a first mark conductor pattern formed in a cross section of the multilayer body 10 that is perpendicular to the coil axis A of the coil L and in which a coil conductor (preferably a coil conductor located at one end or the other end (outermost)) is formed. In other words, in a certain cross section of the multilayer body 10 perpendicular to the coil axis A of the coil L, both the coil conductor (preferably the coil conductor located at one end or the other end (outermost)) and the first mark conductor pattern are preferably exposed. Similarly, the second discrimination mark preferably includes a second mark conductor pattern formed in a cross section of the multilayer body 10 that is perpendicular to the coil axis A of the coil L and in which a coil conductor (preferably a coil conductor located at one end or the other end (outermost)) is formed.

In addition, at least one layer of discrimination mark (one discrimination mark) may be provided on an insulating layer on which the first connection conductor or the second connection conductor is formed, and the remaining discrimination mark may be provided on an insulating layer on which a coil conductor is formed. In other words, as a discrimination mark, only a discrimination mark provided on an insulating layer on which the first connection conductor or the second connection conductor is formed or a discrimination mark provided on an insulating layer on which a coil conductor is formed may be disposed. In addition, the first discrimination mark preferably includes a first mark conductor pattern formed in a cross section of the multilayer body 10 that is perpendicular to the coil axis A of the coil L and in which the first connection conductor is formed, and a first mark conductor pattern formed in a cross section of the multilayer body 10 that is perpendicular to the coil axis A of the coil L and in which a coil conductor is formed. Similarly, the second discrimination mark preferably includes a second mark conductor pattern formed in a cross section of the multilayer body 10 that is perpendicular to the coil axis A of the coil L and in which the second connection conductor is formed, and a second mark conductor pattern formed in a cross section of the multilayer body 10 that is perpendicular to the coil axis A of the coil L and in which a coil conductor is formed.

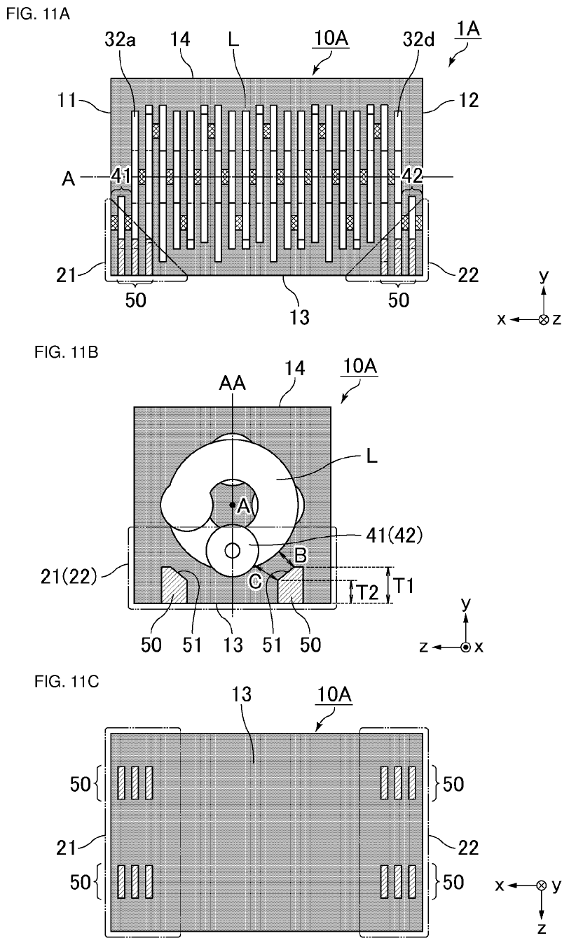

FIG. 11A is a side view schematically illustrating in a see-through manner an example of the internal structure of the multilayer body of the multilayer coil component according to the Second Embodiment of the present disclosure. FIG. 11B is a front view schematically illustrating in a see-through manner an example of the internal structure of the multilayer body of the multilayer coil component according to the Second Embodiment of the present disclosure. FIG. 11C is a bottom view schematically illustrating an example of a first main surface of the multilayer body of the multilayer coil component according to the Second Embodiment of the present disclosure. FIG. 11B illustrates a plan view of the multilayer body from the side where the first outer electrode (or the second outer electrode) is located in the axial direction of the coil.

As illustrated in FIGS. 11A and 11C, in this embodiment as well, the discrimination marks 50 are provided on the first main surface 13 of the multilayer body 10A.

In addition, as illustrated in FIG. 11B, similarly to the First Embodiment, a cutout part 51 is provided in each discrimination mark 50 at a location opposite the coil axis A of the coil L when viewed in plan view in the axial direction of the coil L. Therefore, even if the discrimination marks 50 are made larger (longer in the height direction), an increase in stray capacitance between the outer electrodes electrically connected to the discrimination marks 50 and the coil or connection conductor (in particular, the coil conductor, via conductor, and land on the same layer as the discrimination marks 50 in the case illustrated in FIG. 11B) can be suppressed. The size (dimension in height direction) of the discrimination marks 50 can be made large enough that the discrimination marks 50 are exposed at the first main surface 13 of the multilayer body 10 even if cutting misalignment occurs for the multilayer body block.

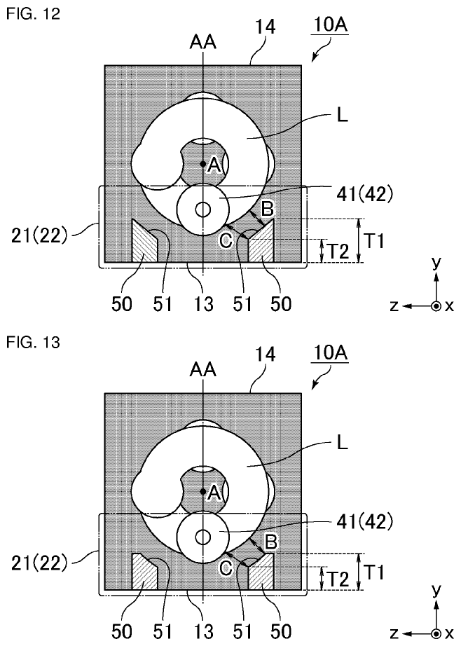

FIG. 12 is a front view schematically illustrating in a see-through manner another example of the internal structure of the multilayer body of the multilayer coil component according to the Second Embodiment of the present disclosure in which a First Modification of a cutout part is illustrated. FIG. 12 illustrates a plan view of the multilayer body from the side where the first outer electrode (or second outer electrode) is located in the axial direction of the coil.

As illustrated in FIGS. 11B and 12, the cutout part 51 of each discrimination mark 50 may have a linear shape. This allows the discrimination marks 50 to be effectively made larger (longer in the height direction) while suppressing an increase in stray capacitance. The discrimination marks 50 may have a pentagonal shape, as illustrated in FIG. 11B, or a quadrangular shape (for example, trapezoidal), as illustrated in FIG. 12.

FIG. 13 is a front view schematically illustrating in a see-through manner yet another example of the internal structure of the multilayer body of the multilayer coil component according to the Second Embodiment of the present disclosure in which a Second Modification of a cutout part is illustrated. FIG. 13 illustrates a plan view of the multilayer body from the side where the first outer electrode (or second outer electrode) is located in the axial direction of the coil.

As illustrated in FIG. 13, the discrimination marks 50 may be shaped such that the cutout parts 51 follow the outer peripheries of the coil conductors (preferably each coil conductor 32a, 32b, 32c, and 32d) when the multilayer body 10 is viewed in plan view in the axial direction of the coil L. This also allows the discrimination marks 50 to be effectively made larger (longer in the height direction) while suppressing an increase in stray capacitance. In this case, the cutout parts 51 may have a curved shape such as an arc shape.

The size of the discrimination marks is not particularly limited, but as illustrated in FIGS. 11B, 12, and 13, in this embodiment, in the case where the discrimination marks are provided at positions shifted from the axis AA perpendicular to the first main surface 13, if the dimensions of the discrimination marks in the height direction of the multilayer body are denoted by T1 for the dimension farther from the axis AA and T2 for the dimension nearer the axis AA, T1 is larger than T2. T1 corresponds to the distance from the first main surface 13 of the highest position in the mark conductor pattern when the multilayer coil component is viewed in plan view in the axial direction of the coil L with the second main surface 14 being on an upper side and the first main surface 13 being on a lower side. T2 corresponds to the distance from the first main surface 13 of the lowest position of the cutout part 51 of the mark conductor pattern when the multilayer coil component is viewed in plan view in the axial direction of the coil L with the second main surface 14 being on an upper side and the first main surface 13 being on a lower side. As illustrated in FIGS. 11B, 12, and 13, when the multilayer coil component is viewed in plan view in the axial direction of the coil L with the second main surface 14 being on an upper side and the first main surface 13 being on a lower side, T1 may be larger than the distance (shortest distance) of the coil L from the first main surface 13 and the distance (shortest distance) of the first connection conductor 41 or the second connection conductor 42 from the first main surface 13, and T2 may be smaller than the distance (shortest distance) of the coil L from the first main surface 13 and the distance (shortest distance) of the first connection conductor 41 or the second connection conductor 42 from the first main surface 13. T1 may be, for example, less than or equal to 10 μm as the dimension after firing. As illustrated in FIGS. 11B, 12, and 13, in this embodiment, a shortest distance B between the coil L and each discrimination mark and a shortest distance C between the first connection conductor 41 or the second connection conductor 42 and each discrimination mark may both be greater than or equal to 5 μm, or greater than or equal to 10 μm. If the shortest distance B between the coil L and the discrimination mark is greater than or equal to 5 μm, an increase in stray capacitance can be suppressed and radio-frequency characteristics are improved. If the shortest distance B is greater than or equal to 10 μm, an increase in stray capacitance can be further suppressed and the radio-frequency characteristics are further improved.

Hereafter, an example of a method of manufacturing the multilayer coil component according to the Second Embodiment of the present disclosure will be described. The multilayer coil component according to this embodiment can be manufactured in substantially the same manner as the multilayer coil component according to the First Embodiment, except for the following points.

In this embodiment, at least one coil sheet is a mark coil sheet on which a mark conductor pattern is formed.

The coil sheets and the mark coil sheets are stacked so that a coil having a coil axis extending in a direction parallel to the mounting surface after cutting is formed inside the multilayer body. In addition, via sheets, in which via conductors that will make up the connection conductors are formed, are stacked above and below the coil sheets. At least one via sheet is a mark via sheet on which a mark conductor pattern is formed. In this way, the multilayer coil component according to the Second Embodiment of the present disclosure can be manufactured.

Note that, in the above embodiment, a case in which a cutout part is provided in the mark conductor pattern constituting each discrimination mark has been described. However, in the multilayer coil component of the present disclosure, it is sufficient to provide a cutout part in at least one mark conductor pattern, and a cutout part may be provided in at least one mark conductor pattern when a plurality of mark conductor patterns are provided. However, from the viewpoint of reducing stray capacitance, it is preferable that cutout parts be provided in all of the mark conductor patterns constituting the discrimination marks.

In the multilayer coil component of the present disclosure, the structure of the multilayer body is not limited to the structures illustrated in FIG. 3 and FIG. 10, and so on. For example, the shapes of the coil conductors or mark conductor patterns can be changed as appropriate. In addition, the number and order of the insulating layers 31e and 31f stacked outside the coil can be changed as appropriate. Note that the insulating layers 31e are not essential.

When the multilayer coil component of the present disclosure is the 0603 size, the distance between the coil conductors in the stacking direction is preferably greater than or equal to 3 μm and less than or equal to 7 μm (i.e., from 3 μm to 7 μm). By setting the distance between the coil conductors in the stacking direction to be greater than or equal to 3 μm and less than or equal to 7 μm (i.e., from 3 μm to 7 μm), the number of turns of the coil can be increased, and therefore electrostatic capacitances between the coil conductors can be reduced and the impedance can be increased. In addition, the transmission coefficient S21 in a radio-frequency band, which will be described later, can also be reduced.

The multilayer coil component of the present disclosure includes the first connection conductor and the second connection conductor described above. This multilayer coil component has excellent radio-frequency characteristics in a radio-frequency band (in particular, greater than or equal to 30 GHz and less than or equal to 80 GHz (i.e., from 30 GHz to 80 GHz)). Therefore, the multilayer coil component is, for example, suitable for use in bias-tee circuits inside optical communication circuits.

In the multilayer coil component of the present disclosure, the transmission coefficient S21 at 40 GHz is evaluated as a radio-frequency characteristic. The transmission coefficient S21 is obtained from the ratio of the power of a transmitted signal to the power of an input signal. The transmission coefficient S21 is basically a dimensionless quantity, but is usually expressed in dB using the common logarithm.

In the multilayer coil component of the present disclosure, the transmission coefficient S21 at 40 GHz is preferably less than or equal to 0 dB and greater than or equal to −1.0 dB.

The following content is disclosed in the present specification.
<1> A multilayer coil component comprising a multilayer body formed by stacking a plurality of insulating layers and including a coil, a first connection conductor, and a second connection conductor thereinside; and a first outer electrode and a second outer electrode that are electrically connected to the coil. The coil is formed by electrically connecting a plurality of coil conductors, which are stacked together with the insulating layers, to one another. The multilayer body has a first end surface and a second end surface, which face each other in a length direction, a first main surface and a second main surface, which face each other in a height direction perpendicular to the length direction, and a first side surface and a second side surface, which face each other in a width direction perpendicular to the length direction and the height direction. The first outer electrode is disposed so as to cover at least part of the first end surface and so as to extend from the first end surface and cover part of the first main surface. The second outer electrode is disposed so as to cover at least part of the second end surface and so as to extend from the second end surface and cover part of the first main surface. The first connection conductor is connected between a part of the first outer electrode that covers the first end surface and the coil conductor that faces that part of the first outer electrode. The second connection conductor is connected between a part of the second outer electrode that covers the second end surface and the coil conductor that faces that part of the second outer electrode. An axial direction of the coil is parallel to the first main surface. A first discrimination mark is provided on a surface of the multilayer body, excluding the first end surface and the second end surface, at a location where the first outer electrode is disposed. The first discrimination mark includes a first mark conductor pattern that is in contact with an inner surface of the first outer electrode and extends along a plane perpendicular to the axial direction of the coil, and the first mark conductor pattern is provided with a cutout part at a location opposite a coil axis of the coil.
<2> The multilayer coil component according to <1>, wherein the first discrimination mark includes two or more of the first mark conductor pattern, the first mark conductor patterns being provided so as to be spaced apart from each other.
<3> The multilayer coil component according to <1> or <2>, wherein the first discrimination mark includes the first mark conductor pattern, the first mark conductor pattern being formed in a cross section of the multilayer body that is perpendicular to the coil axis and in which the first connection conductor is formed.
<4> The multilayer coil component according to <3>, wherein the first mark conductor pattern formed in the cross section in which the first connection conductor is formed is shaped such that the cutout part follows an outer periphery of the first connection conductor when the multilayer body is viewed in plan view in the axial direction of the coil.
<5> The multilayer coil component according to <3> or <4>, wherein the first discrimination mark includes a plurality of the first mark conductor pattern, the first mark conductor patterns including the first mark conductor pattern formed in a cross section of the multilayer body that is perpendicular to the coil axis and in which the first connection conductor is formed, and a first mark conductor pattern formed in a cross section of the multilayer body that is perpendicular to the coil axis and in which one of the coil conductors is formed.
<6> The multilayer coil component according to any one of <1> to <5>, wherein the first discrimination mark includes the first mark conductor pattern, the first mark conductor pattern being formed in a cross section of the multilayer body that is perpendicular to the coil axis and in which one of the coil conductors is formed.
<7> The multilayer coil component according to <6>, wherein the first mark conductor pattern formed in the cross section in which one of the coil conductors is formed is shaped such that the cutout part follows an outer periphery of the coil conductor when the multilayer body is viewed in plan view in the axial direction of the coil.
<8> The multilayer coil component according to any one of <1> to <7>, wherein the first discrimination mark includes the first mark conductor pattern, the cutout part of the first mark conductor pattern having a linear shape.
<9> The multilayer coil component according to any one of <1> to <8>, wherein the first discrimination mark includes a plurality of the first mark conductor pattern, the first mark conductor patterns being symmetrically provided at two locations spaced apart from each other with respect to an axis perpendicular to the first main surface when viewed in plan view in the axial direction of the coil.
<10> The multilayer coil component according to any one of <1> to <9>, wherein the first discrimination mark includes one or more of the first mark conductor pattern, the first mark conductor patterns including only a first mark conductor pattern for which a shortest distance from the coil is greater than or equal to 5 μm or a first mark conductor pattern for which a shortest distance from the first connection conductor is greater than or equal to 5 μm, or including both of these first mark conductor patterns.
<11> The multilayer coil component according to any one of <1> to <10>, wherein the first discrimination mark includes one or more of the first mark conductor pattern, the first mark conductor patterns including only a first mark conductor pattern for which a shortest distance from the coil is greater than or equal to 10 μm or a first mark conductor pattern for which a shortest distance from the first connection conductor is greater than or equal to 10 μm, or including both of these first mark conductor patterns.
<12> The multilayer coil component according to any one of <1> to <11>, wherein when the multilayer coil component is viewed in plan view in the axial direction of the coil with the second main surface on an upper side and the first main surface on a lower side, a distance of a highest position of the first mark conductor pattern from the first main surface is greater than a distance of the coil from the first main surface and a distance of the first connection conductor from the first main surface.
<13> The multilayer coil component according to any one of <1> to <12>, wherein when the multilayer coil component is viewed in plan view in the axial direction of the coil with the second main surface on an upper side and the first main surface on a lower side, a distance of a lowest position of the cutout part of the first mark conductor pattern from the first main surface is smaller than a distance of the coil from the first main surface and a distance of the first connection conductor from the first main surface.
<14> The multilayer coil component according to any one of <1> to <13>, wherein a second discrimination mark is provided on a surface of the multilayer body, excluding the first end surface and the second end surface, at a location where the second outer electrode is disposed. The second discrimination mark includes a second mark conductor pattern that is in contact with an inner surface of the second outer electrode and extends along a plane perpendicular to the axial direction of the coil, and the second mark conductor pattern is provided with a cutout part at a location opposite the coil axis.
<15> The multilayer coil component according to <14>, wherein the second discrimination mark includes two or more of the second mark conductor pattern, the second mark conductor patterns being provided so as to be spaced apart from each other.
<16> The multilayer coil component according to <14> or <15>, wherein the second discrimination mark includes the second mark conductor pattern, the second mark conductor pattern being formed in a cross section of the multilayer body that is perpendicular to the coil axis and in which the second connection conductor is formed.
<17> The multilayer coil component according to <16>, wherein the second mark conductor pattern formed in the cross section in which the second connection conductor is formed is shaped such that the cutout part follows an outer periphery of the second connection conductor when the multilayer body is viewed in plan view in the axial direction of the coil.
<18> The multilayer coil component according to <16> or <17>, wherein the second discrimination mark includes a plurality of the second mark conductor pattern, the second mark conductor patterns including the second mark conductor pattern formed in a cross section of the multilayer body that is perpendicular to the coil axis and in which the second connection conductor is formed, and a second mark conductor pattern formed in a cross section of the multilayer body that is perpendicular to the coil axis and in which one of the coil conductors is formed.
<19> The multilayer coil component according to any one of <14> to <18>, wherein the second discrimination mark includes the second mark conductor pattern, the second mark conductor pattern being formed in a cross section of the multilayer body that is perpendicular to the coil axis and in which one of the coil conductors is formed.
<20> The multilayer coil component according to <19>, wherein the second mark conductor pattern formed in the cross section in which one of the coil conductors is formed is shaped such that the cutout part follows an outer periphery of the coil conductor when the multilayer body is viewed in plan view in the axial direction of the coil.
<21> The multilayer coil component according to any one of <14> to <20>, wherein the second discrimination mark includes the second mark conductor pattern, the cutout part of the second mark conductor pattern having a linear shape.
<22> The multilayer coil component according to any one of <14> to <21>, wherein the second discrimination mark includes a plurality of the second mark conductor pattern, the second mark conductor patterns being symmetrically provided at two locations spaced apart from each other with respect to an axis perpendicular to the first main surface when viewed in plan view in the axial direction of the coil.
<23> The multilayer coil component according to any one of <14> to <22>, wherein the second discrimination mark includes one or more of the second mark conductor pattern, the second mark conductor patterns including only a second mark conductor pattern for which a shortest distance from the coil is greater than or equal to 5 μm or a second mark conductor pattern for which a shortest distance from the second connection conductor is greater than or equal to 5 μm, or including both of these second mark conductor patterns.
<24> The multilayer coil component according to any one of <14> to <23>, wherein the second discrimination mark includes one or more of the second mark conductor pattern, the second mark conductor patterns including only a second mark conductor pattern for which a shortest distance from the coil is greater than or equal to 10 μm or a second mark conductor pattern for which a shortest distance from the second connection conductor is greater than or equal to 10 μm, or including both of these second mark conductor patterns.
<25> The multilayer coil component according to any one of <14> to <24>, wherein when the multilayer coil component is viewed in plan view in the axial direction of the coil with the second main surface on an upper side and the first main surface on a lower side, a distance of a highest position of the second mark conductor pattern from the first main surface is greater than a distance of the coil from the first main surface and a distance of the second connection conductor from the first main surface.
<26> The multilayer coil component according to any one of <14> to <25>, wherein when the multilayer coil component is viewed in plan view in the axial direction of the coil with the second main surface on an upper side and the first main surface on a lower side, a distance of a lowest position of the cutout part of the second mark conductor pattern from the first main surface is smaller than a distance of the coil from the first main surface and a distance of the second connection conductor from the first main surface.

What is claimed is:

1. A multilayer coil component comprising:
a multilayer body including a plurality of insulating layers that are stacked, and a coil, a first connection conductor, and a second connection conductor inside the multilayer body; and
a first outer electrode and a second outer electrode that are electrically connected to the coil,
wherein
the coil is configured by electrically connecting a plurality of coil conductors, which are stacked together with the insulating layers, to one another,
the multilayer body has a first end surface and a second end surface, which face each other in a length direction, a first main surface and a second main surface, which face each other in a height direction perpendicular to the length direction, and a first side surface and a second side surface, which face each other in a width direction perpendicular to the length direction and the height direction,
the first outer electrode covers at least part of the first end surface to extend from the first end surface and cover part of the first main surface,
the second outer electrode covers at least part of the second end surface to extend from the second end surface and cover part of the first main surface,
the first connection conductor is connected between a part of the first outer electrode that covers the first end surface and the coil conductor that faces that part of the first outer electrode,
the second connection conductor is connected between a part of the second outer electrode that covers the second end surface and the coil conductor that faces that part of the second outer electrode,
an axial direction of the coil is parallel to the first main surface,
a first discrimination mark is on a surface of the multilayer body, excluding the first end surface and the second end surface, at a location of the first outer electrode,
the first discrimination mark includes at least one first mark conductor pattern that is in contact with an inner surface of the first outer electrode and extends along a plane perpendicular to the axial direction of the coil, and
the first mark conductor pattern includes a cutout part at a location opposite a coil axis of the coil.

2. The multilayer coil component according to claim 1, wherein
the first discrimination mark includes two or more of the first mark conductor pattern, the first mark conductor patterns being spaced apart from each other.

3. The multilayer coil component according to claim 1, wherein
the first discrimination mark includes the first mark conductor pattern, the first mark conductor pattern is in a cross section of the multilayer body that is perpendicular to the coil axis and in which the first connection conductor is configured.

4. The multilayer coil component according to claim 3, wherein
the first mark conductor pattern in the cross section in which the first connection conductor is configured is shaped such that the cutout part follows an outer periphery of the first connection conductor when the multilayer body is viewed in plan view in the axial direction of the coil.

5. The multilayer coil component according to claim 3, wherein
the first discrimination mark includes a plurality of the first mark conductor pattern, the first mark conductor patterns including the first mark conductor pattern in a cross section of the multilayer body that is perpendicular to the coil axis and in which the first connection conductor is configured, and a first mark conductor pattern in a cross section of the multilayer body that is perpendicular to the coil axis and in which one of the coil conductors is configured.

6. The multilayer coil component according to claim 1, wherein
the first discrimination mark includes the first mark conductor pattern, the first mark conductor pattern being in a cross section of the multilayer body that is perpendicular to the coil axis and in which one of the coil conductors is configured.

7. The multilayer coil component according to claim 6, wherein
the first mark conductor pattern in the cross section in which one of the coil conductors is configured is shaped such that the cutout part follows an outer periphery of the coil conductor when the multilayer body is viewed in plan view in the axial direction of the coil.

8. The multilayer coil component according to claim 1, wherein
the first discrimination mark includes the first mark conductor pattern, the cutout part of the first mark conductor pattern having a linear shape.

9. The multilayer coil component according to claim 1, wherein
the first discrimination mark includes a plurality of the first mark conductor pattern, the first mark conductor patterns being symmetrically present at two locations spaced apart from each other with respect to an axis perpendicular to the first main surface when viewed in plan view in the axial direction of the coil.

10. The multilayer coil component according to claim 1, wherein
the first discrimination mark includes one or more of the first mark conductor pattern, the first mark conductor patterns including only a first mark conductor pattern for which a shortest distance from the coil is greater than or equal to 5 μm or a first mark conductor pattern for which a shortest distance from the first connection conductor is greater than or equal to 5 μm, or including both of these first mark conductor patterns.

11. The multilayer coil component according to claim 1, wherein
the first discrimination mark includes one or more of the first mark conductor pattern, the first mark conductor patterns including only a first mark conductor pattern for which a shortest distance from the coil is greater than or equal to 10 μm or a first mark conductor pattern for which a shortest distance from the first connection conductor is greater than or equal to 10 μm, or including both of these first mark conductor patterns.

12. The multilayer coil component according to claim 1, wherein
when the multilayer coil component is viewed in plan view in the axial direction of the coil with the second main surface on an upper side and the first main surface on a lower side, a distance of a highest position of the first mark conductor pattern from the first main surface is greater than a distance of the coil from the first main surface and a distance of the first connection conductor from the first main surface.

13. The multilayer coil component according to claim 1, wherein
when the multilayer coil component is viewed in plan view in the axial direction of the coil with the second main surface on an upper side and the first main surface on a lower side, a distance of a lowest position of the cutout part of the first mark conductor pattern from the first main surface is smaller than a distance of the coil from the first main surface and a distance of the first connection conductor from the first main surface.

14. The multilayer coil component according to claim 1, wherein
a second discrimination mark is on a surface of the multilayer body, excluding the first end surface and the second end surface, at a location of the second outer electrode,
the second discrimination mark includes a second mark conductor pattern that is in contact with an inner surface of the second outer electrode and extends along a plane perpendicular to the axial direction of the coil, and
the second mark conductor pattern incudes a cutout part at a location opposite the coil axis.

15. The multilayer coil component according to claim 14, wherein
the second discrimination mark includes two or more of the second mark conductor pattern, the second mark conductor patterns is spaced apart from each other.

16. The multilayer coil component according to claim 14, wherein
the second discrimination mark includes the second mark conductor pattern, the second mark conductor pattern being in a cross section of the multilayer body that is perpendicular to the coil axis and in which the second connection conductor is configured.

17. The multilayer coil component according to claim 16, wherein
the second mark conductor pattern in the cross section in which the second connection conductor is configured is shaped such that the cutout part follows an outer periphery of the second connection conductor when the multilayer body is viewed in plan view in the axial direction of the coil.

18. The multilayer coil component according to claim 16, wherein
the second discrimination mark includes a plurality of the second mark conductor pattern, the second mark conductor patterns including the second mark conductor pattern in a cross section of the multilayer body that is perpendicular to the coil axis and in which the second connection conductor is configured, and a second mark conductor pattern in a cross section of the multilayer body that is perpendicular to the coil axis and in which one of the coil conductors is configured.

19. The multilayer coil component according to claim 14, wherein
the second discrimination mark includes the second mark conductor pattern, the second mark conductor pattern being in a cross section of the multilayer body that is perpendicular to the coil axis and in which one of the coil conductors is configured.

20. The multilayer coil component according to claim 19, wherein
the second mark conductor pattern in the cross section in which one of the coil conductors is configured is shaped such that the cutout part follows an outer periphery of the coil conductor when the multilayer body is viewed in plan view in the axial direction of the coil.

21. The multilayer coil component according to claim 14, wherein
the second discrimination mark includes the second mark conductor pattern, the cutout part of the second mark conductor pattern having a linear shape.

22. The multilayer coil component according to claim 14, wherein
the second discrimination mark includes a plurality of the second mark conductor pattern, the second mark conductor patterns being symmetrically present at two locations spaced apart from each other with respect to an axis perpendicular to the first main surface when viewed in plan view in the axial direction of the coil.

23. The multilayer coil component according to claim 14, wherein
the second discrimination mark includes one or more of the second mark conductor pattern, the mark conductor patterns including only a second mark conductor pattern for which a shortest distance from the coil is greater than or equal to 5 μm or a second mark conductor pattern for which a shortest distance from the second connection conductor is greater than or equal to 5 μm, or including both of these second mark conductor patterns.

24. The multilayer coil component according to claim 14, wherein
the second discrimination mark includes one or more of the second mark conductor patterns, the second mark conductor patterns including only a second mark conductor pattern for which a shortest distance from the coil is greater than or equal to 10 μm or a second mark conductor pattern for which a shortest distance from the second connection conductor is greater than or equal to 10 μm, or including both of these second mark conductor patterns.

25. The multilayer coil component according to claim 14, wherein
when the multilayer coil component is viewed in plan view in the axial direction of the coil with the second main surface on an upper side and the first main surface on a lower side, a distance of a highest position of the second mark conductor pattern from the first main surface is greater than a distance of the coil from the first main surface and a distance of the second connection conductor from the first main surface.

26. The multilayer coil component according to claim 14, wherein
when the multilayer coil component is viewed in plan view in the axial direction of the coil with the second main surface on an upper side and the first main surface on a lower side, a distance of a lowest position of the cutout part of the second mark conductor pattern from the first main surface is smaller than a distance of the coil from the first main surface and a distance of the second connection conductor from the first main surface.
